(19) United States
(12) Patent Application Publication
(10) Pub. No.: US 2014/0365923 A1
(43) Pub. Date: Dec. 11, 2014

(54) HOME SCREEN SHARING APPARATUS AND METHOD THEREOF

(71) Applicant: Samsung Electronics Co., Ltd., Gyeonggi-do (KR)

(72) Inventors: Do-Hyung LEE, Seoul (KR); Min-Chul Kim, Seoul (KR); Suk-Jae Lee, Seoul (KR); Ki-Hong Im, Gyeonggi-do (KR)

(73) Assignee: Samsung Electronics Co., Ltd.

(21) Appl. No.: 14/300,933

(22) Filed: Jun. 10, 2014

(30) Foreign Application Priority Data
Jun. 10, 2013 (KR) 10-2013-0065802

(51) Int. Cl. H04L 12/18; G06F 3/0481; G06F 3/0484; G06F 3/01

(52) U.S. Cl. CPC H04L 12/1813; G06F 3/017; G06F 3/0481; G06F 3/04842
USPC 715/758; 715/753

(57) ABSTRACT

A home screen sharing method and apparatus are provided. The method includes generating a home screen including a private area including private data, and a shared area including shared data; displaying the home screen including the private area and the shared area; sharing the shared area with a cloud server; detecting changes to the shared area; and storing the changes to the shared area in the cloud server.

### PRIORITY

This application claims priority under 35 U.S.C. §119(a) to Korean Application Serial No. 10-2013-0065802, which was filed in the Korean Intellectual Property Office on Jun. 10, 2013, the entire content of which is incorporated herein by reference.

### BACKGROUND OF THE INVENTION

1. Field of the Invention

The present invention generally relates to a portable apparatus and a method thereof and, for example to a home screen displayed on the display unit of the portable apparatus.

2. Description of the Related Art

Recently, technology relating to portable apparatuses has been rapidly developing. Specifically, various applications have been developed which, when executed in a portable apparatus, provide various kinds of services to users.

Further, the portable apparatuses may generally display an initial home screen when powered on. The home screen may display icons for executing the various applications. However, conventional portable apparatuses only display the icons on the home screen and do not provide other functions.

According to the conventional art, the home screen is personally edited and seen only by the user of the portable apparatus, and may not be shared with other devices. Accordingly, the home screen is only displayed for the owner of the portable apparatus, but does not provide other services.

### SUMMARY OF THE INVENTION

Therefore, in order to provide a wider variety of services, a technology for sharing the home screen of a portable apparatus with other devices is required

The present invention has been made to address at least the problems and disadvantages described above, and to provide at least the advantages described below. Accordingly, aspects of the present invention provide a home screen sharing apparatus and method that generate and display a home screen divided into a private area, including private data, and a shared area, including shared data.

According to an aspect of the present invention, a home screen sharing method is provided. The method includes generating a home screen including a private area including private data, and a shared area including shared data; displaying the home screen including the private area and the shared area; sharing the shared area with a cloud server; detecting changes to the shared area; and storing the changes to the shared area in the cloud server.

According to another aspect of the present invention, a home screen sharing apparatus is provided. The home screen sharing apparatus includes a controller configured to generate a home screen including a private area including private data, and a shared area including shared data, to display the home screen including the private area and the shared area, to share the shared area with a cloud server, to detect changes made to the shared area, and to store the changes to the shared area in a cloud server; a display unit configured to display the home screen; and a storage unit configured to store the private data and the shared data.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a block diagram illustrating a portable apparatus according to an embodiment of the present invention;

FIG. 2 is a perspective view of the front surface of a portable apparatus according to an embodiment of the present invention;

FIG. 3 is a perspective view of the rear surface of a portable apparatus according to an embodiment of the present invention;

FIG. 4 is a flowchart illustrating a home screen sharing method according to an embodiment of the present invention;

FIGS. 5 and 6 are diagrams illustrating screens on which a home screen sharing method is performed in a portable apparatus according to an embodiment of the present invention;

FIG. 7 is a diagram illustrating a plurality of portable apparatuses and a cloud server that perform a home screen sharing method according to an embodiment of the present invention;

FIGS. 8A, 8B, 9A and 9B are diagrams illustrating screens on which a home screen sharing method is performed in a portable apparatus according to an embodiment of the present invention;

FIG. 10 is a flowchart illustrating a home screen sharing method an to another embodiment of the present invention;

FIGS. 11A and 11B are diagrams illustrating screens on which a home screen sharing method according to an embodiment of the present invention is performed in the portable apparatus;

FIG. 12 is a diagram illustrating a plurality of portable apparatuses and a cloud server that perform the home screen sharing method according to an embodiment of the present invention;

FIGS. 13A, 13B, 14A and 14B are diagrams illustrating screens on which the home screen sharing method is performed in a portable apparatus according to an embodiment of the present invention; and

FIGS. 15A, 15B, 16, 17A, 17B, 18A, 18B, 19A and 19B are diagrams illustrating screens on which a home screen sharing method is performed in a portable apparatus according to an embodiment of the present invention.

### DETAILED DESCRIPTION OF EMBODIMENTS OF THE PRESENT INVENTION

Various embodiments will now be described more fully with reference to the accompanying drawings in which embodiments of the present invention are shown. However, the embodiments described below do not limit the present invention to a specific implementation, but should be construed as including all modifications, equivalents, and replacements included in the spirit and scope of the present invention.

While terms including ordinal numbers, such as “first” and “second,” etc., may be used to describe various components, such components are not limited by the above terms. These terms are used merely for the purpose to distinguish one element from other elements. For example, a first element could be termed a second element, and similarly, a second element could be also termed a first element without departing from the scope of the present invention. As used herein, the term “and/or” includes any and all combinations of one or more of the associated listed items. The terms used in this application are for the purpose of describing particular embodiments only and are not intended to be limiting of the invention. As used herein, singular forms are intended to include plural forms as well, unless the context clearly indicates otherwise. Terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Unless defined otherwise, all terms used herein have the same meaning as commonly understood by those of skill in the art. Such terms as those defined in a generally used dictionary are to be interpreted to have the meanings equal to the contextual meanings in the relevant field of art, and are not to be interpreted to have ideal or excessively formal meanings unless clearly defined in the description. It will be further understood that terms, such as those defined in commonly used dictionaries, should be interpreted as having definitions that are consistent with their definitions in the context of the relevant art and will not be interpreted in an idealized or overly formal sense unless expressly so defined herein.

An apparatus according to an embodiment of the present invention corresponds to an electronic device such as, for example, a personal computer, a terminal apparatus, or a smart TV. The present invention will be described with respect to a portable apparatus, but the present invention is not limited thereto.

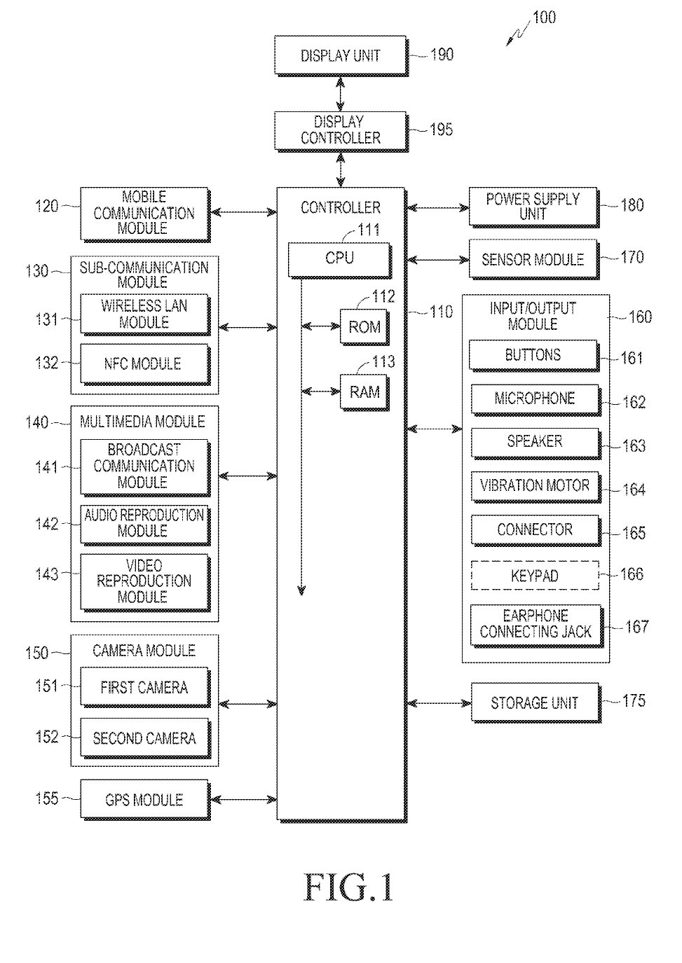

FIG. 1 is a block diagram illustrating a portable apparatus according to an embodiment of the present invention.

With reference to FIG. 1, an apparatus 100 may be connected to an external apparatus (not illustrated) using an external apparatus connecting unit such as a sub-communication module 130, a connector 165, and an earphone connecting jack 167. The “external apparatus” may include various apparatuses such as, for example, earphones, an external speaker, a Universal Serial Bus (USB) memory, a charger, a cradle, a docking station, a Digital Media Broadcasting (DMB) antenna, a mobile payment-related apparatus, a health managing apparatus (for example, blood glucose meter), a game console, a car navigation system, and the like, which are detachably attached to the apparatus 100 and connectable by a wire. Further, the “external apparatus” may include, for example, a Bluetooth communication apparatus, a Near Field Communication (NFC) apparatus, a WiFi Direct communication device, a wireless Access Point (AP), which can be wirelessly connected to the apparatus 100 by a near field communication. Further, the external apparatus may include other apparatuses, a cellular phone, a smart phone, a tablet PC, a desktop PC, or a server.

With reference to FIG. 1, the apparatus 100 includes a display unit 190 and a display controller 195. Further, the apparatus 100 includes a controller 110, a mobile communication module 120, the sub-communication module 130, a multimedia module 140, a camera module 150, a GPS module 155, an input/output module 160, a sensor module 170, a storage unit 175, and a power supply unit 180. The sub-communication module 130 includes at least one of a wireless LAN module 131 and a Near Field Communication (NFC) module 132. The multimedia module 140 includes at least one of a broadcast communication module 141, an audio reproduction module 142, and a video reproduction module 143. The camera module 150 includes at least one of a first camera 151 and a second camera 152. The input/output module 160 includes at least one of buttons 161, a microphone 162, a speaker 163, a vibration motor 164, the connector 165, a key pad 166, and the earphone connecting jack 167. Herein, a description is made in reference to a case in which the display unit 190 and the display controller 195 are embodied as a touch screen and a touch screen controller, respectively.

The controller 110 includes a Central Processing Unit (CPU) 111, a Read Only Memory (ROM) 112, which stores a control program for controlling the apparatus 100, and a Random Access Memory (RAM) 113 that stores a signal or data which is input from the apparatus 100 and that is used as a storage area for an operation performed in the apparatus 100. The CPU 111 may include a single core processor, a dual-core processor, a triple-core processor, or a quad-core processor. The CPU 111, the ROM 112, and the RAM 113 may be interconnected through an internal bus.

The controller 110 may control the mobile communication module 120, the sub-communication module 130, the multimedia module 140, the camera module 150, the GPS module 155, the input/output module 160, the sensor module 170, the storage unit 175, the power supply unit 180, the display unit 190, and the display controller 195.

The mobile communication module 120 connects the apparatus 100 to an external apparatus through mobile communication using one or a plurality of antennas (not shown) under the control of the controller 110. The mobile communication module 120 may transmit or receive a wireless signal for a voice communication, a video communication, a Short Message Service (SMS) or a Multimedia Messaging Service (MMS) with a cellular phone (not shown) having a phone number input to the apparatus 100, a smart phone (not shown), and a tablet PC or other apparatus (not shown).

The sub-communication module 130 may include at least one of the wireless LAN module 131 and the NFC module 132. Alternatively, the sub-communication module 130 may include the wireless LAN module 131 only or the NFC module 132 only.

The wireless LAN module 131 may be connected to the Internet in a location in which a wireless Access Point (AP) (not shown) is installed under the control of the controller 110. The wireless LAN module 131 conforms to the wireless LAN standard (IEEE802.11x) of Institute of Electrical and Electronics Engineers (IEEE). The NFC module 132 may wirelessly perform a near field communication between the apparatus 100 and an image forming apparatus (not shown) under the control of the controller 110. The near field communication scheme may include Bluetooth, Infrared Data Association (IrDA), a WiFi-Direct communication, a Near Field Communication (NFC), and the like.

The apparatus 100 may include at least one of the mobile communication module 120, the wireless LAN module 131, and the NFC module 132. For example, the apparatus 100 may include any combination of the mobile communication module 120, the wireless LAN module 131, and/or the NFC module 132 depending on the performance requirements of the apparatus 100.

The multimedia module 140 may include the broadcast communication module 141, the audio reproduction module 142, and/or the video reproduction module 143. The broadcast communication module 141 may receive a broadcast signal (for example, a TV broadcast signal, a radio broadcast signal, or a data broadcast signal) and additional broadcast information (for example, Electric Program Guide (EPG) or Electric Service Guide (ESG)) transmitted from the broadcasting station through a broadcast communication antenna (not shown) under the control of the controller 110. The audio reproduction module 142 may reproduce a digital audio file (for example, a file with an extension of mp3, wma, ogg, or way) stored or received under the control of the controller 110. The video reproduction module 143 may reproduce a digital video file (for example, a file with an extension of mpeg, mpg, mp4, avi, mov, or mkv) stored or received under the control of the controller 110. The video reproduction module 143 may also reproduce a digital audio file.

The multimedia module 140 may include the audio reproduction module 142 and the video reproduction module 143 and not the broadcast communication module 141. Further, the audio reproduction module 142 or the video reproduction module 143 of the multimedia module 140 may be included in the controller 110.

The camera module 150 may include at least one of the first camera 151 and the second camera 152 that captures a still image or a moving image under the control of the controller 110. Further, the first camera 151 or the second camera 152 may include an auxiliary light source (for example, a flash) that provides an amount of light required for image capturing. The first camera 151 may be disposed on the front surface of the apparatus 100, and the second camera 152 may be disposed on the rear surface of the apparatus 100. According to another embodiment, the first camera 151 and the second camera 152 may be arranged adjacent to each other to capture a three-dimensional still image or a three-dimensional moving image.

The GPS module 155 may receive a radio wave from a plurality of GPS satellites (not shown) in the Earth's orbit, and may calculate a location of the apparatus 100 using Time of Arrival (TOA) from the GPS satellites (not shown) to the apparatus 100.

The input/output module 160 may include at least one of the plurality of buttons 161, the microphone 162, the speaker 163, the vibration motor 164, the connector 165, and the key pad 166.

The buttons 161 may be arranged on the front surface, a side surface, or the rear surface of the housing of the apparatus 100, and may include at least one of a power/lock button, a volume button, a menu button, a home button, a back button, and a search button.

The microphone 162 receives an input voice or an input sound under the control of the controller 110 to generate an electric signal.

The speaker 163 may output sounds corresponding to signals (for example, a wireless signal, a broadcast signal, a digital audio file, a digital video file, or image capturing) from the mobile communication module 120, the sub-communication module 130, the multimedia module 140, or the camera module 150, to the outside of the apparatus 100 under the control of the controller 110. The speaker 163 may also output sounds (for example, a button operation sound or a ring tone corresponding to a phone call) corresponding to a function performed by the apparatus 100. One or more speakers 163 may be formed in a predetermined position or positions of the housing of the apparatus 100.

The vibration motor 164 may convert an electric signal into a mechanical vibration under the control of the controller 110. For example, when the apparatus 100 in the vibration mode receives a voice call from another apparatus (not shown), the vibration motor 164 operates. One or more vibration motors 164 may be formed in the housing of the apparatus 100. The vibration motor 164 may operate in response to a touch operation of the user who touches the display unit 190 and continuous movements of a touch on the display unit 190.

The connector 165 may be used as an interface for connecting the apparatus 100 to an external apparatus (not shown) or a power source (not shown). The apparatus 100 may transmit data stored in the storage unit 175 of the apparatus 100 through a wire cable connected to the connector 165 under the control of the controller 110 to an external apparatus (not shown) or receive data from an external apparatus (not shown). At this point, the external apparatus may be a docking station, and the data may be an input signal transmitted from an external input apparatus such as a mouse, or a keyboard. Further, the apparatus 100 may receive an input electric power from a power source (not shown) through a wire cable connected to the connector 165 or recharge a battery (not shown) using the power source.

The key pad 166 receives a key input from a user for controlling the apparatus 100. The key pad 166 includes a physical key pad (not shown) formed on the apparatus 100 or a virtual key pad (not shown) displayed on the display unit 190. The physical key pad (not shown) formed on the apparatus 100 may be excluded according to the performance or the structure of the apparatus 100.

Earphones (not shown) may be inserted into an earphone connecting jack 167 to be connected to the apparatus 100.

The sensor module 170 includes at least one sensor that detects a status of the apparatus 100. For example, the sensor module 170 may include a proximity sensor that detects whether a user approaches to the apparatus 100 and an illumination sensor that detects a light amount around the apparatus 100. Further, the sensor module 170 may include a gyro sensor. The gyro sensor may detect an operation of the apparatus 100 (for example, a rotation of the apparatus 100, or acceleration or vibration applied to the apparatus 100), detect a point of the compass using the earth's magnetic field, or detect a working direction of the gravity. Further, the sensor module 170 may include an altimeter that measures the air pressure to detect an altitude. The at least one sensor may detect a status, generate a signal corresponding to the detection, and transmit the generated signal to the controller 110. The at least one sensor of the sensor module 170 may be added or deleted depending on the performance of the apparatus 100.

The storage unit 175 may store an input/output signal or data corresponding to operations of the mobile communication module 120, the sub-communication module 130, the multimedia module 140, the camera module 150, the GPS module 155, the input/output module 160, the sensor module 170, and the display unit 190 under the control of the controller 110. The storage unit 175 may store a control program and an application for controlling the apparatus 100 or the controller 110.

The term “storage unit” includes the storage unit 175, the ROM 112 in the controller 110, the RAM 113, and a memory card (not shown) (for example, an SD card or a memory stick) installed on the apparatus 100. The storage unit may include a non-volatile memory, a volatile memory, a Hard Disk Drive (HDD), or a Solid State Drive (SSD).

The power supply unit 180 may supply electric power to one or more batteries (not shown) arranged in the housing of the apparatus 100 under the control of the controller 110. The one or more batteries (not shown) supply electric power to the apparatus 100. Further, the power supply unit 180 may supply electric power input to the apparatus 100 from an external power source (not shown) through a wire cable connected to the connector 165. Further, the power supply unit 180 may supply electric power wirelessly input to the apparatus 100 from an external power source through a wireless recharging technology.

The display unit 190 may provide the user with user interfaces corresponding to various services (for example, a phone, data transmission, broadcast, and photograph). The display unit 190 may transmit an analog signal corresponding to at least one touch input to the user interface to the display controller 195. The display unit 190 may receive at least one touch input through the body of the user (for example, a finger including the thumb) or a touchable input means (for example, a stylus pen). Further, the display unit 190 may receive a continuous movement of one touch input among the at least one touch. The display unit 190 may transmit an analog signal corresponding to the continuous movement of the touch input to the display controller 195.

The touch according to the present invention is not limited to contact between the body of the user or the touchable input unit and the display unit 190, and may include non-contact input. A distance that can be detected by the display unit 190 may be changed depending on the performance or the structure of the apparatus 100.

The display unit 190 may be utilize, for example, a resistive touch scheme, a capacitive touch scheme, an infrared touch scheme, or an acoustic wave touch scheme.

The display controller 195 converts the analog signal received from the display unit 190 into a digital signal (for example, X and Y coordinates), and transmits the converted signal to the controller 110. The controller 110 may control the display unit 190 using the digital signal received from the display controller 195. For example, the controller 110 may select a shortcut icon (not shown) displayed on the display unit 190 or execute the shortcut icon (not shown), in response to the touch. Further, the display controller 195 may be included in the controller 110.

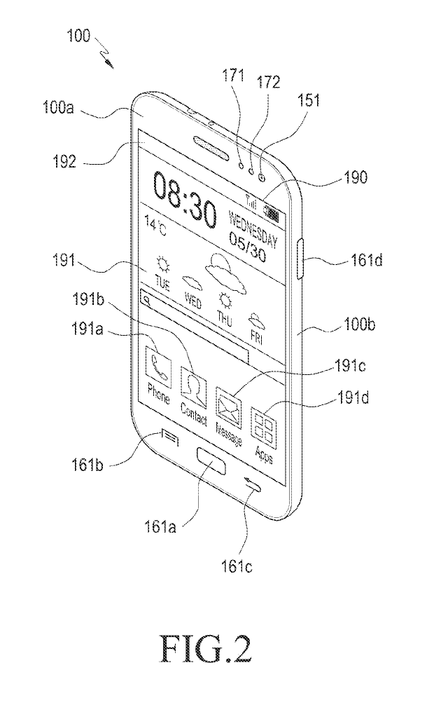

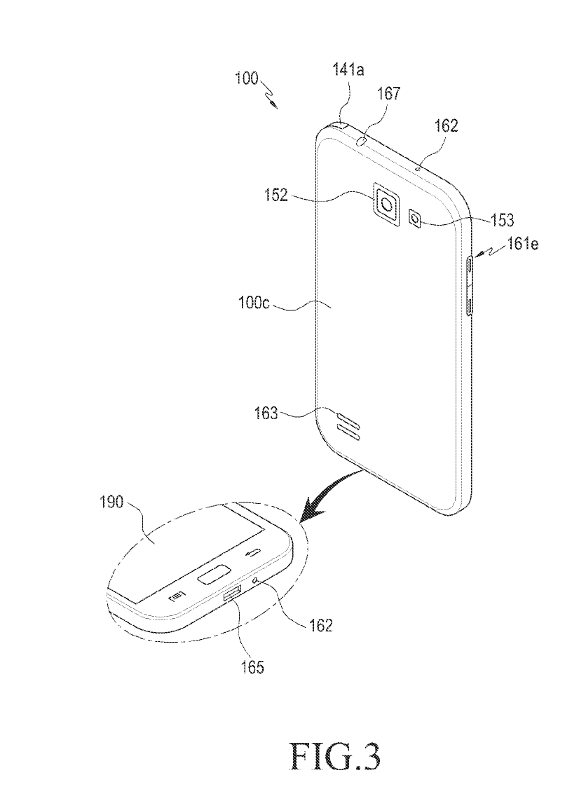

FIG. 2 is a perspective view of the front surface of a portable apparatus according to an embodiment of the present invention. FIG. 3 is a perspective view of the rear surface of a portable apparatus according to an embodiment of the present invention.

With reference to FIG. 2, the display unit 190 is disposed in the center of a front surface 100a of the apparatus 100. The display unit 190 is formed to occupy most of the front surface 100a of the apparatus 100. FIG. 2 illustrates an example in which a main home screen is displayed on the display unit 190. The main home screen is a first screen displayed on the display unit 190 when the apparatus 100 is powered on. Further, if the apparatus 100 has several pages of home screens, the main home screen may be the first home screen among the several pages of the home screens. Shortcut icons 191a, 191b, and 191c for executing frequently used applications, an application switching key 191d, time, weather, and the like may be displayed on the home screen. The application switching key 191d enables application icons to be displayed on the display unit 190. Further, a status bar 192 indicating the status of the apparatus 100 such as the battery recharging status, the intensity of a received signal, or current time may be formed on the upper portion of the display unit 190.

A home button 161a, a menu button 161b, and a back button 161c may be formed on the lower portion of the display unit 190.

The home button 161a is used for displaying a main home screen on the display unit 190. For example, when the main home screen, another home screen, or a menu screen is displayed on the display unit 190, if the home button 161a is pushed (or touched), the main home screen may be displayed on the display unit 190. Further, when applications are executed on the display unit 190, if the home button 161a is pushed (or touched), the main home screen illustrated in FIG. 2 may be displayed on the display unit 190. Further, the home button 161a may be used to display recently used applications or a task manager on the display unit 190.

The menu button 161b provides a connection menu that can be used on the display unit 190. The connection menu may include a widget adding menu, a wallpaper changing menu, a search menu, an editing menu, a configuration setting menu, or the like. Further, when executing an application, a connection menu connected to the application may be provided.

The back button 161c may be used for displaying a screen that was displayed right before the currently displayed screen or for ending the most recently used application.

The first camera 151, an illuminance sensor 171, and a proximity sensor 172 may be arranged on the edge of the front surface 100a of the apparatus 100. The second camera 152, a flash 153, and the speaker 163 may be arranged on the rear surface 100c of the apparatus 100.

For example, a power/reset button 161d, a volume button 161e, a terrestrial DMB antenna 141a for receiving broadcasts, one or more microphones 162, or the like may be arranged on a side surface 100b of the apparatus 100. The DMB antenna 141a may be fixed or detachably attached to the apparatus 100.

Further, the connector 165 may be provided on the side surface of the lower portion of the apparatus 100. A plurality of electrodes are arranged on the connector 165, and may be connected to an external apparatus by wire. The earphone connecting jack 167 may be provided on the side surface of the upper portion of the apparatus 100. Earphones may be inserted into the earphone connecting jack 167.

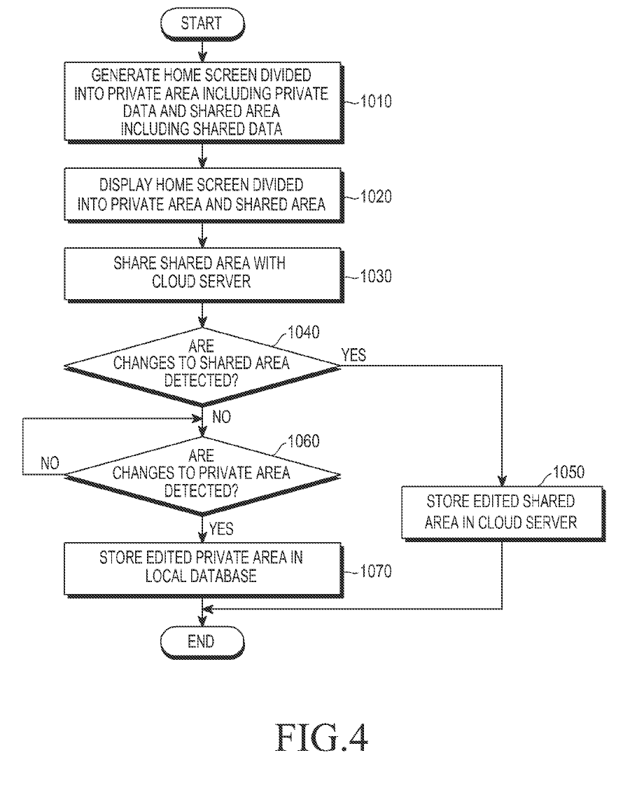

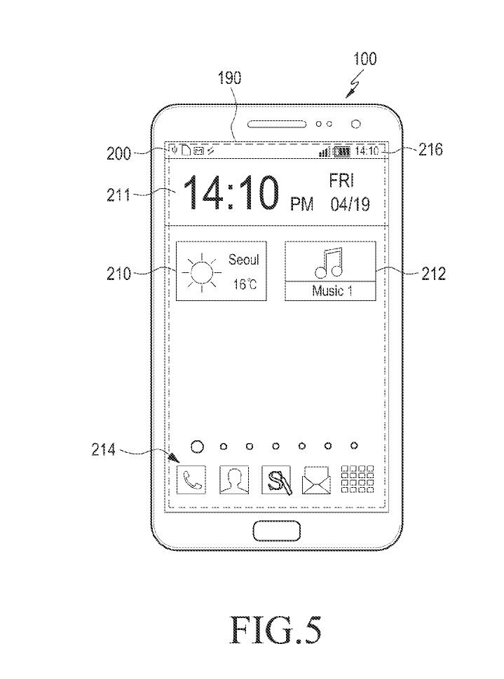

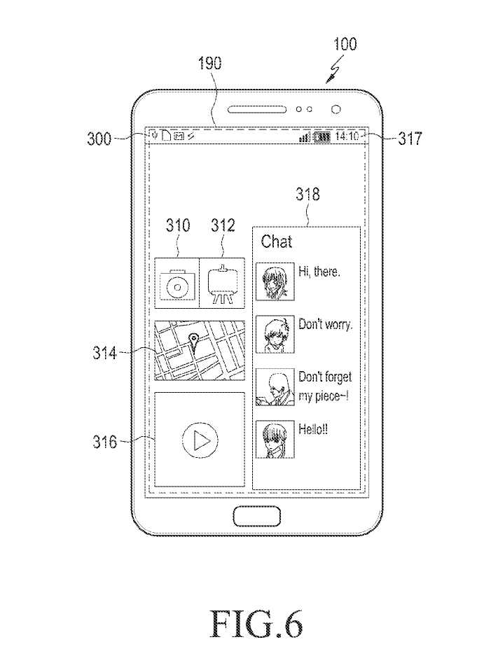

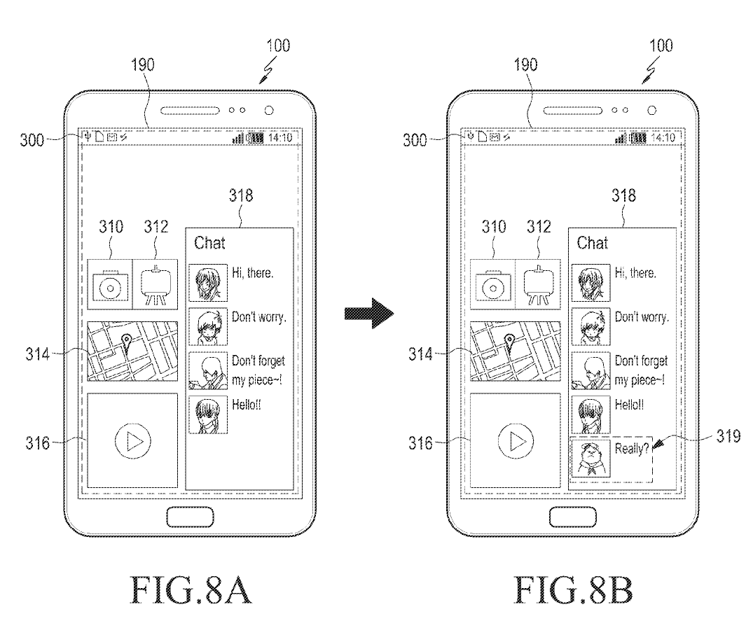

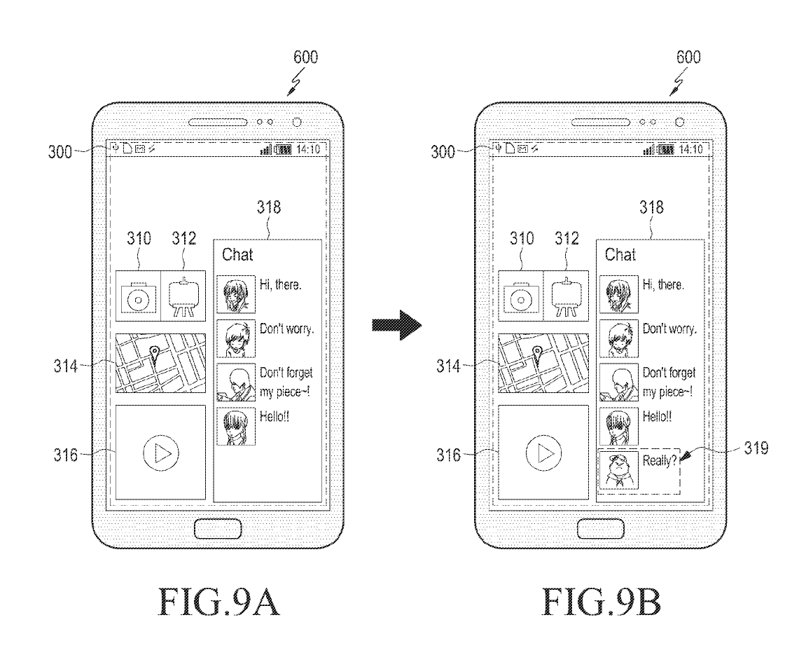

FIG. 4 is a flowchart illustrating a home screen sharing method according to an embodiment of the present invention. FIGS. 5 and 6 are diagrams illustrating screens on which a home screen sharing method is performed in a portable apparatus according to an embodiment of the present invention. FIGS. 8A to 9B are diagrams illustrating screens on which a home screen sharing method is performed in a portable apparatus according to an embodiment of the present invention.

With reference to FIG. 4, the home screen sharing method according to an embodiment of the present invention includes generating a home screen which is divided into a private area, including private data, and a shared area, including shared data, in step 1010. The controller 110 of the portable apparatus 100 may generate a home screen which is divided into the private area, including private data, and the shared area, including shared data. That is, the controller 110 may divide and control the private area and the shared area and generate the private area and the shared area, respectively. Further, the controller 110 may generate a home screen which is divided into the private area and the shared area.

The home screen may be the first screen displayed on the display unit when the portable apparatus 100 is powered on. Further, the home screen may be a screen which is displayed in a standby status of the portable apparatus 100. In addition, the home screen may be the first screen displayed when the lock status of the portable apparatus 100 is released.

The controller 110 may generate a home screen formed with a private area including private data. The private area may refer to a personal area of the home screen which is not shared. That is, the private area may refer to an area on the home screen which is not shared through a cloud server as described below. Further, the private data may refer to data included in the private area to form the home screen.

The private data may include at least one of content, an image, text, an audio file, a video, a shortcut, a widget, a notification, a status bar, an application, a blog, an Social Networking Service (SNS), and a chat window included in the private area of the home screen.

For example, the controller 110 may generate the home screen formed with the private area including the private data including at least one of a widget, content, a shortcut, or a status bar.

For example, the controller 110 may generate the home screen formed with the private area including the private data including at least one of a weather widget, clock widget, an audio file Music 1, a phone, contacts, a note, a message, a shortcut like an application list (Apps), and a status bar.

Further, the controller 110 may generate a home screen formed with the shared area including shared data. The shared area may refer to an area shared in the home screen. That is, the shared area may refer to an area on the home screen which is shared through the cloud server as described below. Further, the shared data may refer to data included in the shared area for forming the home screen.

The shared data may include at least one of content, an image, text, an audio file, a video, a shortcut, a widget, a notification, a status bar, an application, a blog, an SNS, and a chat window.

For example, the controller 110 may generate the home screen formed with the shared area including the shared data including at least one of a shortcut, a widget, a video, and a chat window. For example, the controller 110 may generate the home screen formed with the shared area including the shared data including at least one of a shortcut for a camera application, a shortcut for a paint application, a map widget, a video, a chat window, and a status bar.

Further, the shared data may be formed based on Hyper Text Markup Language (HTML) standard web. HTML may refer to a programming language used to generate a document displayed by one of the Internet services, World Wide Web. Further, the HTML may be defined by the international standard. Therefore, if the shard data is formed with HTML, the shared data may be shared based on the Internet web as an HTML standard.

Therefore, the controller 110 may generate a home screen divided into the private area and the shared area. That is, the controller 110 may generate a home screen divided into the private area including the private data and the shared area including the shared data. In step 1020, the home screen which is divided into the private area and the shared area is displayed. The controller 110 displays the home screen divided into the private area and the shared area on the display unit 190.

The controller 110 may display the private area on the display unit 190 together with the shared area. Further, the controller 110 may display the private area on the display unit 190 by separating the private area from the shared area.

That is, the controller 110 may display the home screen formed with the private area including the private data on the display unit 190. For example, the controller 110 may display the home screen formed with the private area including the private data including at least one of a widget, content, a shortcut, and a status bar on the display unit 190.

For example, with reference to FIG. 5, the controller 110 of the portable apparatus 100 may display the home screen formed with the private area 200 including the private data 210 to 216 on the display unit 190. That is, the controller 110 may display the home screen formed with the private area 200 including the private data 210 to 216 including at least one of the widget, content, a shortcut, and a status bar, on the display unit 190. For example, as illustrated in FIG. 5, the controller 110 displays the home screen formed with the private area 200 including the private data including at least one of weather widget 210, clock widget 211, an audio file Music 1 212, a phone, contacts, a note, a message, a shortcut 214 like an application list (Apps), and a status bar 216 on the display unit 190.

Further, the controller 110 may display the home screen formed with the shared area including the shared data, on the display unit 190. For example, the controller 110 may display the home screen formed with the shared area including the shared data including at least one of an application, a widget, a video, and a chat window on the display unit 190.

For example, with reference to FIG. 6, the controller 110 of the portable apparatus 100 may display the home screen formed with the shared area 300 including the shared data 310 to 318 on the display unit 190. That is, the controller 110 may display the home screen formed with the shared area 300 including the shared data 310 to 318 including at least one of a shortcut, a widget, a video, and a chat window on the display unit 190. For example, as illustrated in FIG. 6, the controller 110 may display the home screen formed with the shared area 300 including the shared data including at least one of a shortcut 310 for a camera application, a shortcut 312 for a paint application, a map widget 314, a video 316, a chat window 318, and a status bar 317 on the display unit 190.

In step 1030, the shared area is shared with a cloud server. The controller 110 of the portable apparatus 100 may share the shared data with the cloud server. That is, the controller 110 may share the shared area including the shared data with the cloud server.

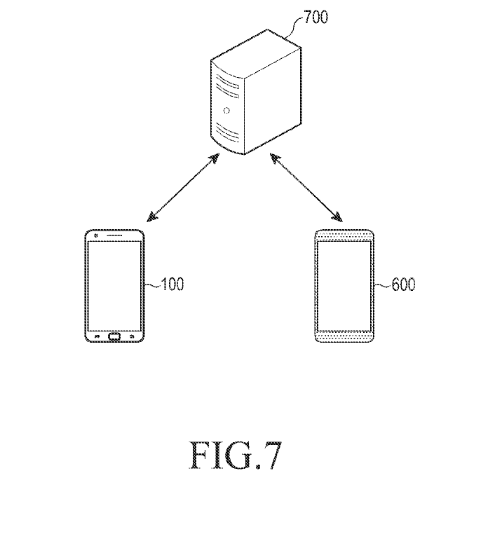

FIG. 7 is a diagram illustrating a plurality of portable apparatuses and a cloud server that perform the home screen sharing method according to an embodiment of the present invention. FIG. 7 illustrates a first portable apparatus 100 and a second portable apparatus 600 corresponding to the plurality of portable apparatuses and a cloud server 700. The shared area forming the home screen may be shared between the first portable apparatus 100 and the second portable apparatus 600 corresponding to the plurality of portable apparatuses via the cloud server 700.

For example, when the shared area forming the home screen is formed in the first portable apparatus 100, the controller 110 of the first portable apparatus 100 may transmit data relating to the shared area to the cloud server 700, using the mobile communication module 120 or the sub-communication module 130. Therefore, the first portable apparatus 100 may share the shared data with the cloud server 700 by transmitting the data relating to the shared area to the cloud server 700. In addition, the second portable apparatus 600 may request the shared area from the cloud server 700 using a communication module. The cloud server 700 may then transmit the shared area to the second portable apparatus 600. Therefore, the second portable apparatus 600 may receive the shared area forming the home screen generated in the first portable apparatus 100 from the cloud server 700. In the same manner, the second portable apparatus 600 may share the shared area forming the home screen generated in the first portable apparatus 100 with the first portable apparatus 100 via the cloud server 700.

For example, the home screen formed with the shared area received by the second portable apparatus 600 through the cloud server 700 may be the home screen as illustrated in FIG. 6. For example, as illustrated in FIG. 9A, the second portable apparatus 600 may display the home screen formed with the shared area 300 including the shared data including at least one of the shortcut 310 for the camera application, the shortcut 312 for the paint application, the map widget 314, the video 316, the chat window 318, and the status bar 317, on the display unit. Therefore, the second portable apparatus 600 may display the home screen formed with the shared area of the first portable apparatus 100 illustrated in FIG. 6 on the display unit of the second apparatus 600 via the cloud server 700 as illustrated in FIG. 9A.

In step 1040, changes to the shared area are detected. The controller 110 of the portable apparatus 100 may detect changes to the shared area. The changes may include, for example, copying, moving, adding, or deleting. Therefore, the controller 110 may detect the changes such as the copying, moving, adding, or deleting of the contents in the shared area.

FIGS. 8A and 8B are diagrams illustrating screens on which a home screen sharing method according to an embodiment of the present invention is performed in the portable apparatus. FIG. 8A illustrates the home screen formed with the shared area. The shared data including at least one of the shortcut 310 for the camera application, the shortcut 312 for the paint application, the map widget 314, the video 316, the chat window 318, and the status bar 317 may be displayed on the shared area of the home screen illustrated in FIG. 8A. At this point, the controller 110 may detect changes to the shared area. For example, the controller 110 may detect changes such as the addition of content. As illustrated in FIG. 8B, a conversation 319 in the chat window 318 may be added. Here, the controller 110 may detect the addition of the conversation 319 to detect the changing of the shared area such as the adding.

In step 1050, if the changes to the shared data are detected, the changed shared area is stored in the cloud server. If the controller 110 detects changes to the shared area, the changed shared area is stored in the cloud server. That is, the controller 110 may transmit the changed shared area to the cloud server and the cloud server may store the changed shared area.

For example, if the first portable apparatus 100 detects changes to the shared area 300, the controller 110 of the first portable apparatus 100 may transmit data relating to the changed shared area to the cloud server 700 using the mobile communication module 120 or the sub-communication module 130. Therefore, the first portable apparatus 100 may share the changed shared area with the cloud server 700 in real time by transmitting the data relating to the changed shared area to the cloud server 700. Further, the cloud server 700 may transmit the data relating to the changed shared area to the second portable apparatus 600. Therefore, the second portable apparatus 600 may receive the changed shared area changed in the first portable apparatus 100 via the cloud server 700. Therefore, the second portable apparatus 600 may share the changed shared area changed in the first portable apparatus 100 via the cloud server 700 with the first portable apparatus 100 in real time.

FIGS. 9A and 9B are diagrams illustrating screens on which a home screen sharing method according to an embodiment of the present invention is performed in the portable apparatus. FIG. 9A illustrates the home screen formed with the shared area in the second portable apparatus 600. The shared area of the home screen illustrated in FIG. 9A may display the shared data including at least one of the shortcut 310 for the camera application, the shortcut 312 for the paint application, the map widget 314, the video 316, the chat window 318, and the status bar 317. The second portable apparatus 600 may display the changed shared area changed in the first portable apparatus 100 received from the cloud server 700 on the home screen of the second portable apparatus 600. For example, the change detected in the first portable apparatus 100 may be the addition of conversation 319 in the chat window 318, as illustrated in FIGS. 8A and 8B. At this point, the second portable apparatus 600 may display the conversation 319 added in the chat window 318 on the home screen as illustrated in FIG. 9B. Therefore, the second portable apparatus 600 may display the shared area changed in the first portable apparatus 100 illustrated in FIGS. 8A and 8B on the home screen of the second portable apparatus 500 in the same manner. Therefore, the second portable apparatus 600 may share the changed shared area changed in the first portable apparatus 100 via the cloud server 700 together with the first portable apparatus 100 in real time.

In step 1060, changes to the private area are detected. The controller 110 of the portable apparatus 100 may detect changes to the private area. Such changes may include, for example, copying, moving, adding, or deleting information. Therefore, the controller 110 may detect changes to the private area such as copying, moving, adding, or deleting.

For example, the controller 110 may display the home screen formed with the private area 200 including the private data including at least one of the weather widget 210, the clock widget 211, an audio file Music 1 212, a phone, contacts, a note, a message, and the shortcut 214 like an application list (Apps), and the status bar 216 on the display unit 190 as illustrated in FIG. 5. At this point, the controller 110 may detect changes to the private area. For example, the controller 110 may detect deletion of information. For instance, the controller 110 may detect the deletion of the audio file Music 1 212.

In step 1070, when changes to the private area are detected, the changed private area is stored in the local database. When the controller 110 detects changes to the private area, the controller 110 may store the changed private area in the local database. The local database is included in the storage unit 175 of the portable apparatus 100. Therefore, the private area is not shared with the cloud server 700.

For example, the controller 110 may display the home screen formed with the private area 200 including the private data including at least one of the weather widget 210, the clock widget 211, the audio file Music 1 212, a phone, contacts, a note, a message, the shortcut 214 like an application list (Apps), and the status bar 216 on the display unit 190, as illustrated in FIG. 5. At this point, when the controller 110 detects the deletion of the audio file Music 1 212, the controller 110 may store the changed private area from which the audio file Music 1 212 is deleted in the local database. Therefore, since the changed private area is stored in the local database included in the storage unit 175, the private area may not be shared through the cloud server 700. Therefore, according to an embodiment of the present invention, the changed shared area may be shared among the plurality of portable apparatuses through the cloud server, but the changed private area may not be shared among the plurality of portable apparatuses.

Therefore, the embodiment of the present invention has an advantage of generating and displaying a home screen which is divided into a private area, including private data, and a shared area, including shared data. Further, the embodiment of the present invention has an advantage of sharing the home screen formed with a shared area among a plurality of portable apparatuses through the cloud server. Further, the embodiment of the present invention has an advantage of sharing the changed shared area among the plurality of portable apparatuses through the cloud server in real time, if changes to the shared area are detected.

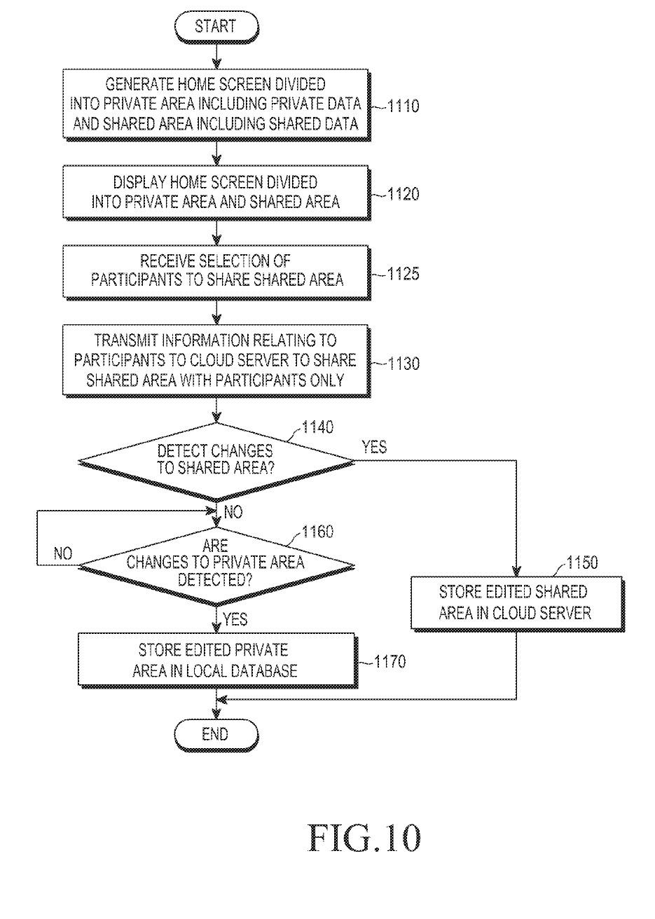

FIG. 10 is a flowchart illustrating a home screen sharing method according to another embodiment of the present invention.

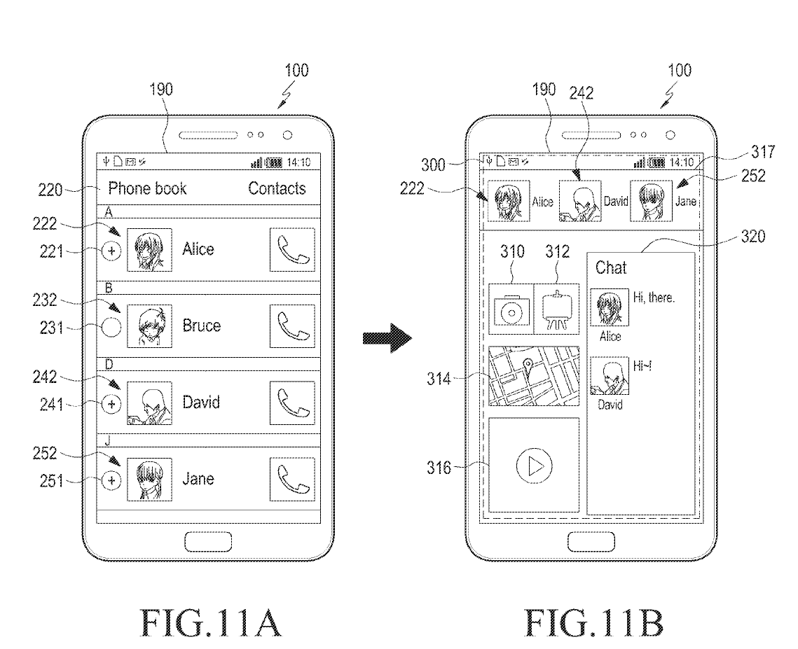

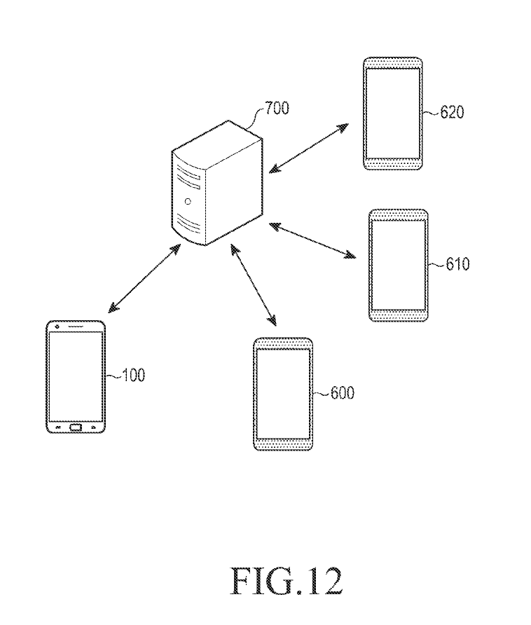

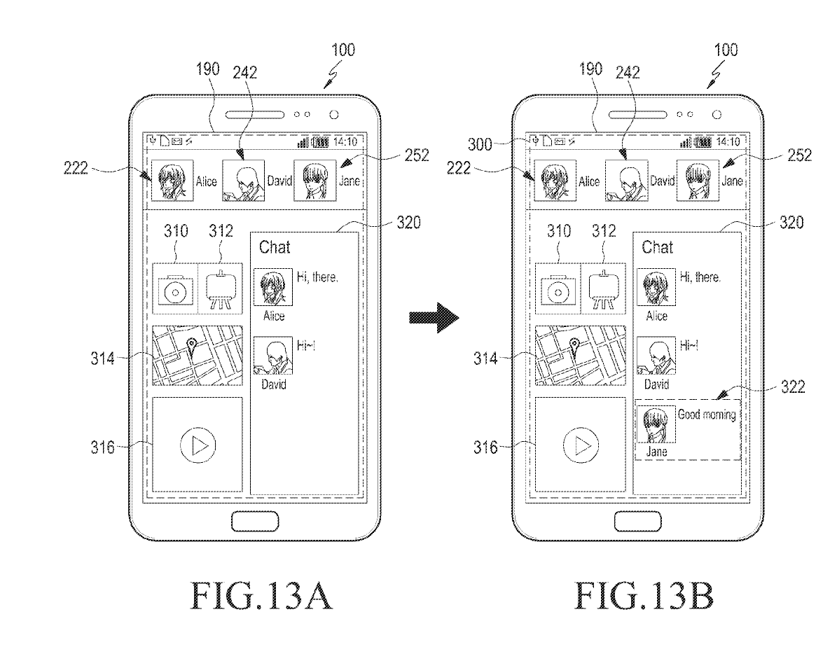

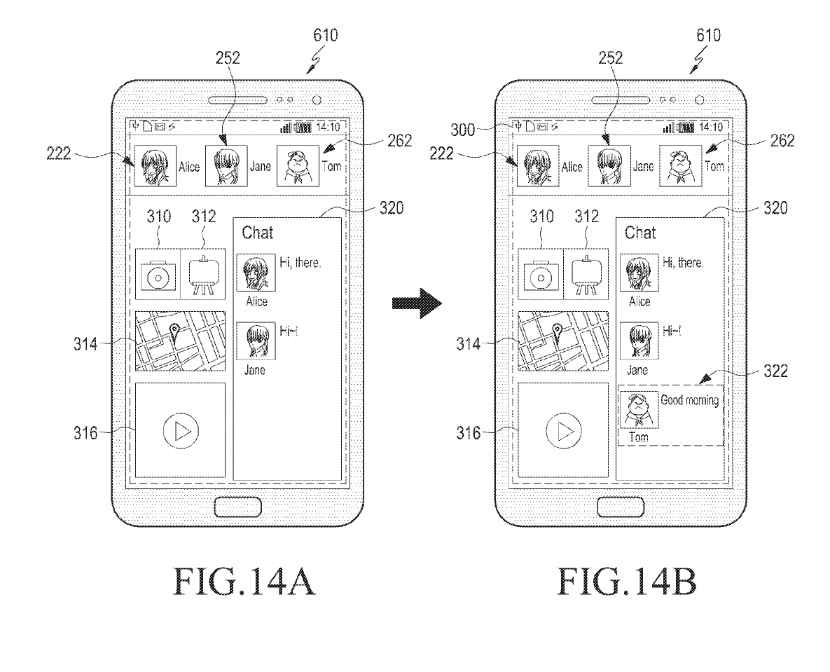

FIGS. 11A and 11B are diagrams illustrating screens on which a home screen sharing method according to an embodiment of the present invention is performed in the portable apparatus. FIG. 12 is a diagram illustrating a plurality of portable apparatuses and a cloud server that perform a home screen sharing method according to an embodiment of the present invention. FIGS. 13A to 14B are diagrams illustrating screens on which the home screen sharing method is performed in a portable apparatus according to an embodiment of the present invention. Hereinafter, with reference to FIGS. 10 to 14B, the home screen sharing method according to an embodiment of the present invention is displayed.

Referring to FIG. 10, the home screen sharing method according to another embodiment of the present invention first generates a home screen which is divided into a private area, including private data, and a shared area, including shared data in step 1110. The controller 110 of the portable apparatus 100 may generate the home screen divided into a private area including private data and a shared area including shared data. That is, the controller 110 may divide and generate the private area and the shared area. Further, the controller 110 may generate a home screen divided into the private area and the shared area.

The home screen may be the first screen displayed on the display unit when the portable apparatus 100 is powered on. Further, the home screen may be the screen displayed in the standby status of the portable apparatus 100. Further, the home screen may be the first screen displayed when the lock status of the portable apparatus 100 is released.

The controller 110 may generate the home screen formed with a private area including private data. The private area may refer to a personal area of the home screen which is not shared. That is, the private area may refer to an area on the home screen which is not shared through the cloud server described below. Further, the private data may refer to data included in the private area for forming the home screen.

The private data may include at least one of content, an image, text, an audio file, a video, a shortcut, a widget, a notification, a status bar, an application, a blog, an SNS, or a chat window included in the private area of the home screen.

For example, the controller 110 may generate the home screen formed with the private area including the private data including at least one of the widget, the content, the shortcut, and the status bar. For example, the controller 110 may generate the home screen formed with the private area including the private data including at least one of a weather widget, a clock widget, an audio file Music 1, a phone, contacts, a note, a message, a shortcut like an application list (Apps), and a status bar.

Further, the controller 110 may generate the home screen formed with the shared area including the shared data. The shared area may refer to an area of the home screen which is shared. That is, the shared area may refer to an area on the home screen shared through the cloud server described below. Further, the shared data may refer to data included in the shared area for forming the home screen.

The shared data may include at least one of the content, the image, the text, the audio, the video, the shortcut, the widget, the notification, the status bar, the application, the blog, the SNS, and the chat window.

For example, the controller 110 may generate the home screen formed with the shared area including the shared data including at least one of the shortcut, the widget, the video, and the chat window. For example, the controller 110 may generate the home screen formed with the private area including the private data including at least one of a shortcut for the camera application, a shortcut of the paint application, map widget, a video, chat window, and a status bar.

Further, the shared data may be formed based on the HTML standard web. HTML may refer to a programming language used to generate a document displayed by one of the Internet services, World Wide Web. Further, HTML may be defined by the international standard. Therefore, if the shared data is formed with HTML, the shared data may be shared based on the Internet web as an HTML standard.

Therefore, the controller 110 may generate the home screen divided into the private area and the shared area. That is, the controller 110 may generate the home screen divided into the private area including the private data and the shared area including the shared data. In step 1120, the home screen divided into the private area and the shared area is displayed. The controller 110 may display the home screen divided into the private area and the shared area on the display unit 190.

At this point, the controller 110 may display the private area together with the shared area on the display unit 190. Further, the controller 110 may display the private area by separating the private area from the shared area on the display unit 190.

That is, the controller 110 may display the home screen formed with the private area including the private data on the display unit 190. For example, the controller 110 displays the home screen formed with the private area including the private data including at least one of the widget, the content, the shortcut, or the status bar, on the display unit 190.

For example, with reference to FIG. 5, the controller 110 of the portable apparatus 100 may display the home screen formed with the private area 200 including the private data 210 to 216 on the display unit 190. That is, the controller 110 may display the home screen formed with the private area 200 including the private data 210 to 216 including at least one of the widget, the content, the shortcut, or the status bar on the display unit 190. For example, as illustrated in FIG. 5, the controller 110 may display the home screen formed with the private area 200 including the private data including at least one of the weather widget 210, the clock widget 211, the audio file Music 1 212, the phone, the contacts, the note, the message, and the shortcut 214 like an application list (Apps) and the status bar 216 on the display unit 190.

Further, the controller 110 may display the home screen formed with the shared area including the shared data on the display unit 190. For example, the controller 110 may display the home screen formed with the shared area including the shared data including at least one of the application, the widget, the video, and the chat window, on the display unit 190.

For example, with reference to FIG. 11B, the controller 110 of the portable apparatus 100 may display the home screen formed with the shared area 300 including the shared data 310 to 320 on the display unit 190. That is, the controller 110 may display the home screen formed with the shared area 300 including the shared data 310 to 320 including at least one of the shortcut, the widget, the video, and the chat window on the display unit 190. For example, as illustrated in FIG. 11B, the controller 110 may display the home screen formed with the shared area 300 including the shared data including at least one of the shortcut 310 for the camera application, the shortcut 312 for the paint application, the map widget 314, the video 316, the chat window 320, and the status bar 317 on the display unit 190. In step 1125, participants to share the shared area are selected. The controller 110 may receive a selection of participants to share the shared area. At this point, the participants may be selected using the contacts stored in the phone book.

That is, the shared area may be shared among the selected participants only. Therefore, a portable apparatus that does not correspond to the selected participants may not share the shared area with the cloud server. At this point, the controller 110 may receive a selection of participants to share the shared area with the cloud server. Further, the participants may be one or a plurality of participants.

Further, the controller 110 may receive a selection of the participants using the contacts included in the phone book. The phone book may refer to a storage area or an application that stores contacts for using the communication function in the portable apparatus 100. With reference to FIG. 11A, the phone book 220 is displayed on the display unit 190. In addition, the phone book 220 includes the contacts 222 to 252 to be displayed on the display unit 190. For example, the contacts may be Alice 222, Bruce 232, David 242, and Jane 252 as illustrated in FIG. 11A. Further, the contacts may include an image associated with each contact.

At this point, the controller 110 may receive a selection of the participants by detecting a selection of add icons 221 to 251 corresponding to each of the contacts 222 to 252, respectively, of the phone book 220. With reference to FIG. 11A, the add icon 221 may be displayed, for example, on the left end of the contact of Alice 222. If a gesture (for example, a touch or hovering) for selecting the add icon 221 is detected, the controller 110 may determine that the contact of Alice 222 is selected as the participant. In addition, if the contact of Alice 222 is selected, a plus (+) mark may be added and displayed on the add icon 221. Therefore, in FIG. 11A, since the plus marks are additionally displayed on the contacts of Alice 222, David 242, and Jane 252, the contacts of Alice 222, David 242, and Jane 252 are selected as the participants.

Subsequently, the shared area is shared with the cloud server. In step 1130, the information relating to the participants is transmitted to the cloud server so that the shared area can be shared only with the selected participants. That is, the controller 110 may transmit the information relating to the participants to the cloud server so that the shared area can be shared only with the selected participants.

FIG. 12 is a diagram illustrating a plurality of portable apparatuses and a cloud server that perform a home screen sharing method according to another embodiment of the present invention. FIG. 12 illustrates a first portable apparatus 100, a second portable apparatus 600, a third portable terminal 610, and a fourth portable terminal 620 corresponding to the plurality of portable apparatuses and the cloud server 700. The shared area that forms the home screen may be shared among the first portable apparatus 100, the second portable apparatus 600, the third portable terminal 610, and the fourth portable terminal 620 corresponding to the plurality of portable apparatuses via the cloud server 700.

For example, if the shared area that forms the home screen is generated in the first portable apparatus 100, the controller 110 of the first portable apparatus 100 may transmit the data relating to the shared area to the cloud server 700 using the mobile communication module 120 or the sub-communication module 130. At this point, the controller 110 of the first portable apparatus 100 may enter an input to transmit information relating to the participants to the cloud server 700 so that the shared area can be shared only among the selected participants. Further, the second portable apparatus 600, the third portable terminal 610, or the fourth portable terminal 620 corresponding to the participants may request the shared area that forms the home screen from the cloud server 700 using a communication module. Further, the cloud server 700 may transmit the shared area that forms the home screen only to the second portable apparatus 600, the third portable terminal 610, or the fourth portable terminal 620 corresponding to the participants. That is, the cloud server 700 may not transmit the shared area that forms the home screen to a portable apparatus that does not correspond to the participants. Therefore, the second portable apparatus 600, the third portable terminal 610, or the fourth portable terminal 620 corresponding to the participants may receive the shared area that forms the home screen generated in the first portable apparatus 100 through the cloud server 700. Therefore, the second portable apparatus 600, the third portable terminal 610, or the fourth portable terminal 620 corresponding to the participants may share the shared area that forms the home screen generated in the first portable apparatus 100 through the cloud server 700 with the first portable apparatus 100.

For example, the home screen, including the shared area generated in the first portable apparatus 100, may be the home screen 300 illustrated in FIG. 11B. The home screen illustrated in FIG. 11B may be formed with the shared area 300 including the shared data including at least one of the shortcut 310 for the camera application, the shortcut 312 for the paint application, the map widget 314, the video 316, the chat window 318, and the status bar 317. The home screen may also display information relating to the participants. The information relating to the participants may include the images and/or the names of the participants. With reference to FIG. 11B, the participants may be Alice 222, David 242, and Jane 252. The controller 110 may further display information 222, 242, and 252 relating to the participants such as images and/or names of Alice 222, David 242, and Jane 252 which are the participants. Therefore, the second portable apparatus 600, the third portable terminal 610, or the fourth portable terminal 620 corresponding to the participants may receive the home screen including the shared area 300 as illustrated in FIG. 11B generated in the first portable apparatus 100 via the cloud server 700 and display the home screen on the display unit.

Therefore, the second portable apparatus 600, the third portable terminal 610, or the fourth portable terminal 620 corresponding to the participants may share the home screen including the shared area 300 generated in the first portable apparatus 100 via the cloud server 700. In step 1140, changes to the shared area are detected. At this point, the changes may be performed only by an input from a generator who has generated the shared area or inputs from the generator and all the participants. That is, the controller 110 may detect the changes to the shared area only by an input from the generator who has generated the shared area. Alternatively, the controller 110 may detect changes to the shared area by inputs of the generator or all the participants.

Further, the changes may include, for example, copying, moving, adding, or deleting. Therefore, the controller 110 may detect the changes such as editing, copying, moving, or deleting the shared area.

For example, the generator may be the first portable apparatus 100, and the participants may be the second portable apparatus 600, the third portable terminal 610, or the fourth portable terminal 620. At this point, the changes to the shared area may be detected only by an input from the first portable apparatus 100 who is the generator. For example, if the shared area is a private blog, only the person who has generated the blog generally edits the blog. Therefore, if the shared area is a blog, changes to the shared area may only be made by an input of the generator.

Alternatively, changes to the shared area may not only be made by an input from the first portable apparatus 100, who is the generator, but also by inputs from the second portable apparatus 600, the third portable terminal 610, and the fourth portable terminal 620 who are the participants. For example, if the shared area is a chat window, not only can the person who generated the chat window input text, but the participants of the chat may also input text. Therefore, if the shared area is a chat, changes to the shared area can be made not only by an input from the generator but also by inputs from the participants.

For example, FIG. 13A illustrates the home screen formed with the shared area of the first portable apparatus 100, which is the apparatus of the generator. The shared data including at least one of the shortcut 310 for the camera application, the shortcut 312 for the paint application, the map widget 314, the video 316, the chat window 320, and the status bar 317 is displayed in the shared area of the home screen of the first portable apparatus 100, which is the apparatus of the generator illustrated in FIG. 13A. At this point, the controller 110 may detect changes to the shared area. For example, the controller 110 may detect additions to the shared area. As illustrated in FIG. 13B, the text 322 may be added to the chat window 320. Here, the controller 110 detects the addition of the conversation 322 thus detecting changes to the shared area.

In step 1150, if changes to the shared area are detected, the changed shared area is stored in the cloud server. If the controller 110 detects changes to the shared area, the controller 110 stores the changes to the shared area in the cloud server. That is, the controller 110 may transmit the changed shared area to the cloud server, and the cloud server may store the changed shared area.

For example, if changes to the shared area are detected from the first portable apparatus 100, the controller 110 of the first portable apparatus 100 may transmit the data relating to the changed shared area to the cloud server 700 using the mobile communication module 120 or the sub-communication module 130. Therefore, the first portable apparatus 100 may share the changed shared area with the cloud server 700 in real time by transmitting the data relating to the changed shared area to the cloud server 700. In addition, the cloud server 700 may transmit the data relating to the changed shared area to the second portable apparatus 600, the third portable terminal 610, and the fourth portable terminal 620. Therefore, the second portable apparatus 600, the third portable terminal 610, and the fourth portable terminal 620 may receive the changed shared area changed in the first portable apparatus 100 via the cloud server 700. Therefore, the second portable apparatus 600, the third portable terminal 610, and the fourth portable terminal 620 may share the changed shared area changed in the first portable apparatus 100 through the cloud server 700 together with the first portable apparatus 100 in real time.

For example, FIG. 14A illustrates the home screen formed with the shared area in the second portable apparatus 600. The shared area of the home screen illustrated in FIG. 14A may display the shared area including at least one of the shortcut 310 for the camera application, the shortcut 312 for the paint application, the map widget 314, the video 316, the chat window 320, or the status bar 317. At this point, the second portable apparatus 600 may display the changed shared area changed in the first portable apparatus 100 received from the cloud server 700 on the home screen. For example, as illustrated in FIGS. 13A and 13B, the changes detected in the first portable apparatus 100 may be the addition of the text 322 to the chat window 320. At this point, as illustrated in FIG. 14B, the second portable apparatus 600 may display the text 322 added in the chat window 320 on the home screen of the second portable apparatus 600. Therefore, the second portable apparatus 600 may display the shared area changed in the first portable apparatus 100 as illustrated in FIGS. 13A and 13B on the home screen in the same manner. Therefore, the second portable apparatus 600 may share the changed shared area changed in the first portable apparatus 100 through the cloud server 700 together with the first portable apparatus 100 in real time.

Subsequently, the changed of the private area is detected in step 1160. The controller 110 of the portable apparatus 100 may detect changes to the private area. At this point, the changes may be copying, moving, adding, or deleting. Therefore, the controller 110 may detect the changes such as the copying, moving, adding, or deleting of information in the private area.

With reference to FIG. 5, for example, the controller 110 may display the home screen formed with the private area 200 including at least of the weather widget 210, the clock widget 211, the audio file Music 1 212, the phone, the contacts, the note, the message, the shortcut 214 such as the application list (Apps), and the status bar 216 on the display unit 190. At this point, the controller 110 may detect changes to the private area. For example, the controller 110 may detect a change such as the deletion of data. For example, the controller 110 may detect the deletion of the audio file Music 1 212.

Subsequently, if the changes to the private area are detected, the changed private area is stored in the local database in step 1170. The controller 110 may store the changed private area in the local database if changes to the private area are detected. The local database may be included in the storage unit 175 of the portable apparatus 100. Therefore, since the changed private area is stored in the local database included in the storage unit 175, the private database may not be shared through the cloud server 700.

With reference to FIG. 5, for example, the controller 110 may display the home screen formed with the private area 200 which comprises of the private data including at least one of the weather widget 210, the clock widget 211, the audio file Music 1 212, the phone, the contact, the note, the message, the shortcut 214 like the application list (Apps), and the status bar 216 on the display unit 190. At this point, if the controller 110 detects the deletion of the audio file Music 1 212, the changed private area from which the audio file Music 1 212 is deleted may be stored on the local database. Therefore, since the changed private area is stored in the local database included in the storage unit 175, the private area may not be shared through the cloud server 700. Therefore, according to another embodiment of the present invention, the changed shared area may be shared among the plurality of portable apparatuses through the cloud server, but the changed private area may not be shared among the plurality of portable apparatuses.

Therefore, the present invention has the advantage of sharing the shared area among participants by receiving a selection of the participants and transmitting the information relating to the participants to the cloud server. In addition, the present invention also has the advantage of being able to restrict the change of the shared area to only the generator who has generated the shared area or to allow inputs from the generator and all the participants.

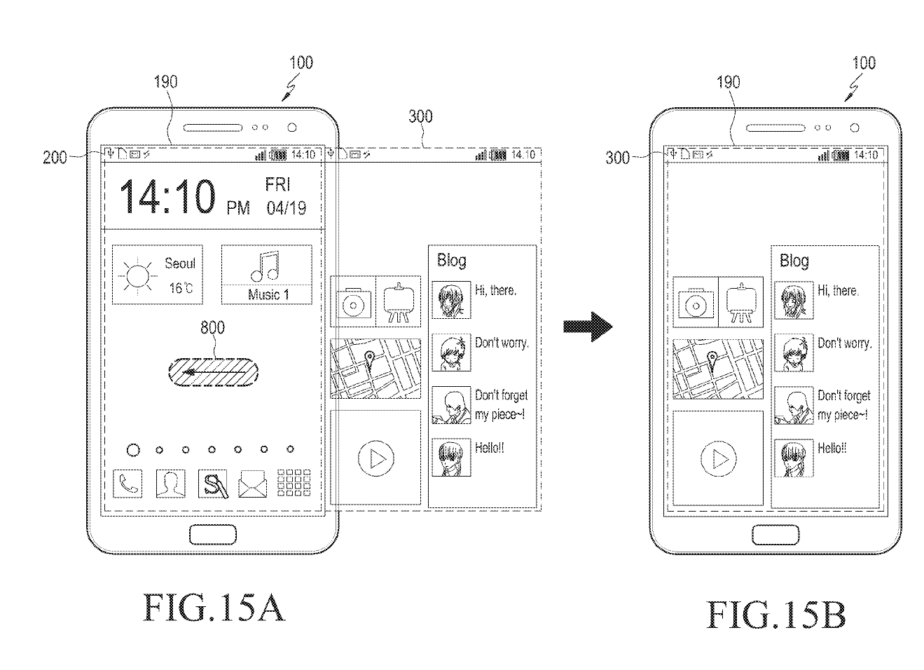

FIGS. 15 to 19 are diagrams illustrating screens on which a home screen sharing method according to another embodiment of the present invention is performed in the portable apparatus.

Hereinafter, with reference to FIGS. 4, and 15 to 19, a description is made of the home screen sharing method according to another embodiment of the present invention.

With reference to FIG. 4, the home screen sharing method according to another embodiment of the present invention includes generating a home screen divided into a private area including private data and a shared area including shared data in step 1010. The controller 110 of the portable apparatus 100 generates the home screen divided into the private area including the private data and the shared area including the shared data. That is, the controller 110 may divide the private area and the shared area and generate the private area and the shared area, respectively. Further, the controller 110 may generate the home screen divided into the private area and the shared area.

The home screen may be the first screen displayed on the display unit when the portable apparatus 100 is powered on. Further, the home screen may be a screen displayed in the standby status of the portable apparatus 100. Further, the home screen may be the first screen displayed when the lock status of the portable apparatus 100 is released.

The controller 110 may generate the home screen formed with the private area including the private data. The private area may refer to a personal area of the home screen that is not shared. That is, the private area may refer to an area on the home screen which is not shared through the cloud server described below. Further, the private area may refer to data included in the private area to form the home screen.

The private data may include at least one of the content, an image, text, an audio file, a video, a shortcut, a widget, a notification, the status bar, an application, a blog, a SNS, and a chat window included in the private area of the home screen.

For example, the controller 110 may generate the home screen including the private area that is comprised of private data which includes at least one of a widget, content, a shortcut, or the status bar. For example, the controller 110 may generate the home screen formed with the private area which is comprised of private data that includes at least of the weather widget, the clock widget, the audio file Music 1, the phone, a contact list, a note, a message, a shortcut like the application list (Apps), and the status bar.

Further, the controller 110 may generate the home screen formed with the shared area including shared data. The shared area may mean the area in the home screen which is shared. That is, the shared area may refer to an area of the home screen which is shared through the cloud server described below. Further, the shared data may refer to data included in the shared area in order to form the home screen.

The shared data may include at least one of content, an image, text, an audio file, a video, a shortcut, a widget, a notification, the status bar, an application, a blog, an SNS, and a chat window.

For example, the controller 110 may generate the home screen formed with the shared area which is comprised of shared data that includes at least one of a shortcut, a widget, a video, and a chat window. For example, the controller 110 may generate the home screen formed with the private area including the private data that includes at least one of a shortcut for a camera application, a shortcut for a paint application, map widget, a video, chat window, and a status bar.

Further, the shared data may be formed based on the HTML standard web. HTML may refer to a programming language used to generate a document displayed by one of the Internet services, World Wide Web. Further, HTML may be defined by the international standard. Therefore, if the shared data is formed with HTML, the shared data may be shared based on the Internet web as an HTML standard.

Therefore, the controller 110 may generate the home screen divided into the private area and the shared area. That is, the controller 110 may generate a home screen divided into a private area including private data and a shared area including shared data. Subsequently, the home screen divided into the private area and the shared area is displayed in step 1020. The controller 110 may display the home screen divided into the private area and the shared area on the display unit 190. At this point, the controller 110 may display the private area together with the shared area on the display unit 190. Further, the controller 110 may separate the private area from the shared area to be displayed on the display unit 190.

In addition, the home screen may be a plurality of home screen pages, the plurality of home screen pages may include a first home screen page displaying the private area and a second home screen page displaying the shared area, and the first home screen page and the second home screen page may be moved by a gesture and displayed.

The controller 110 may display the first home screen page formed with the private area including the private data on the display unit 190. For example, the controller 110 may display the first home screen page formed with the private area which is comprised of private data including at least one of a widget, content, a shortcut, or the status bar on the display unit 190.

For example, with reference to FIG. 15A, the controller 110 of the portable apparatus 100 may display the first home screen page 200 formed with the private area including the private data on the display unit 190. That is, the controller 110 may display the first home screen page 200 formed with the private area comprised of private data which includes at least one of a widget, content, a shortcut, or the status bar on the display unit 190. Further, the controller 110 may display the second home screen page formed with the shared area including the shared data on the display unit 190. For example, the controller 110 may display the second home screen page formed with the shared area including the shared data which includes at least one of an application, a widget, a video, and a chat window on the display unit 190.

For example, with reference to FIG. 15A, the controller 110 of the portable apparatus 100 may display the second home screen page 300 formed with the shared area including the shared data on the display unit 190. That is, the controller 110 may display the second home screen page 300 formed with the shared area including the shared data which includes at least one of an application, a widget, a video, and a chat window on the display unit 190.

Further, the second home screen page 300 may not be displayed temporarily since the first home screen page 200 is displayed first on the display unit. If the first home screen page 200 is displayed on a large portion of the display unit 190 as illustrated in FIG. 15A, the second home screen page 300 on the right side of the first home screen page 200 may not be displayed temporarily.

Further, the first home screen page and the second home screen page may be moved by a gesture and displayed. The gesture may be a touch or hovering that drags the first home screen page or the second home screen page in a specific direction. Therefore, the controller 110 may move and display the first home screen page and the second home screen page in response to detecting a gesture such as the touch or hovering for dragging the first home screen page or the second home screen page.

For example, as illustrated in FIGS. 15A and 15B, the first home screen page 200 is first displayed on the display unit (FIG. 15A), and the second home screen page 300 positioned on the right side of the first home screen page 200 may not be displayed temporarily. At this point, the controller 110 may detect the touch or hovering 800 for dragging the first home screen page 200 to the left. Further, the controller 110 may detect the touch or hovering 800 for dragging the first home screen page 200 to the left to move the first home screen page 200 to the left, and display the second home screen page 300 on the display unit as illustrated in FIG. 15B.

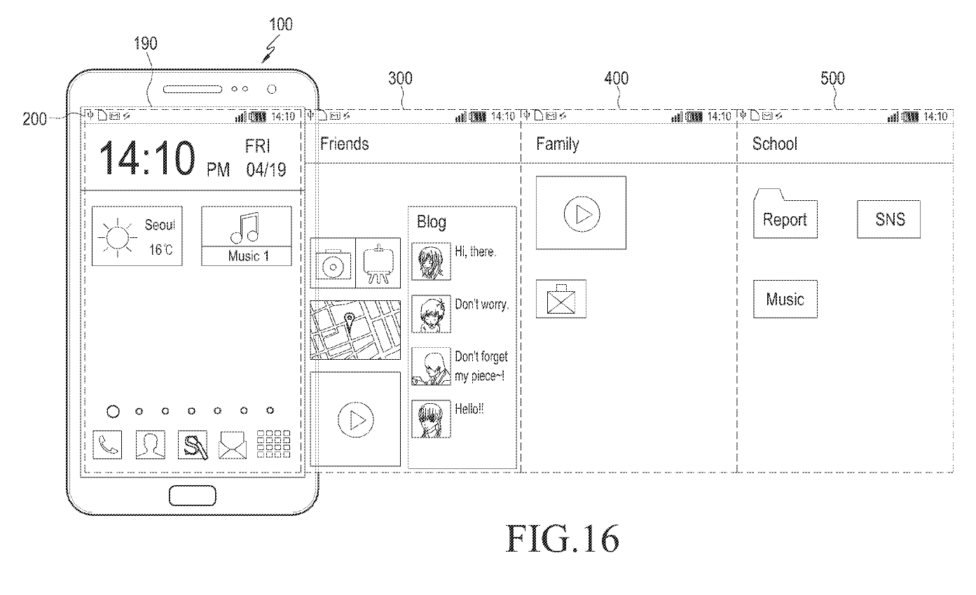

Further, the shared area may be a plurality of shared areas, and the plurality of shared areas may be categorized into groups. For example, with reference to FIG. 16, the shared area may be a plurality of shared areas 300, 400, and 500. Further, the plurality of shared areas may be categorized into groups such as friends 300, family 400, and school 500. For example, in the case of the shared area 400 corresponding to family, the shared area 400 may be shared only with family through the cloud server. Therefore, the shared area may be shared through the cloud server only among people included in a category through a plurality of categorized shared areas.

In step 1030, the shared area is shared with the cloud server in step 1030. The controller 110 of the portable apparatus 100 may share the shared area with the cloud server. That is, the controller 110 may share the shared area including the shared data with the cloud server.

With reference to FIG. 7, the first portable apparatus 100 and the second portable apparatus 600 corresponding to the plurality of portable apparatuses, and the cloud server 700 are illustrated. At this point, the shared area forming the home screen may be shared between the first portable apparatus 100 and the second portable apparatus 600 corresponding to the plurality of portable apparatuses through the cloud server 700.

For example, when the shared area forming the home screen in the first portable apparatus 100 is generated, the controller 110 of the first portable apparatus 100 may transmit data relating to the shared area to the cloud server 700 using the mobile communication module 120 or the sub-communication module 130. Therefore, the first portable apparatus 100 may share the shared area with the cloud server 700 by transmitting to the data relating to the shared area to the cloud server 700. Further, the second portable apparatus 600 may request the shared area forming the home screen from the cloud server 700 using a communication module. In addition, the cloud server 700 may transmit the shared area forming the home screen to the second portable apparatus 600. Therefore, the second portable apparatus 600 may receive the shared area forming the home screen generated in the first portable apparatus 100 through the cloud server 700. Therefore, the second portable apparatus 600 may share the shared area forming the home screen generated in the first portable apparatus 100 through the cloud server 700 with the first portable apparatus 100. Subsequently, changes to the shared area are detected in step 1040. The controller 110 of the portable apparatus 100 may detect the changes to the shared area. At this point, the changes may be copying, moving, adding, or deleting. Therefore, the controller 110 may detect the changes such as the copying, moving, adding, or deleting information in the shared area. At this point, the changes may be the moving or the copying of private data from the private area to the shared area, the moving or the copying of the shared data from the shared area to the private area, or the deleting of the shared data in the shared area. That is, the controller 110 may detect the moving or the copying between the private area and the shared area, or the deleting.

Further, changes such as the moving, copying, or deleting may be detected by sensing a gesture.

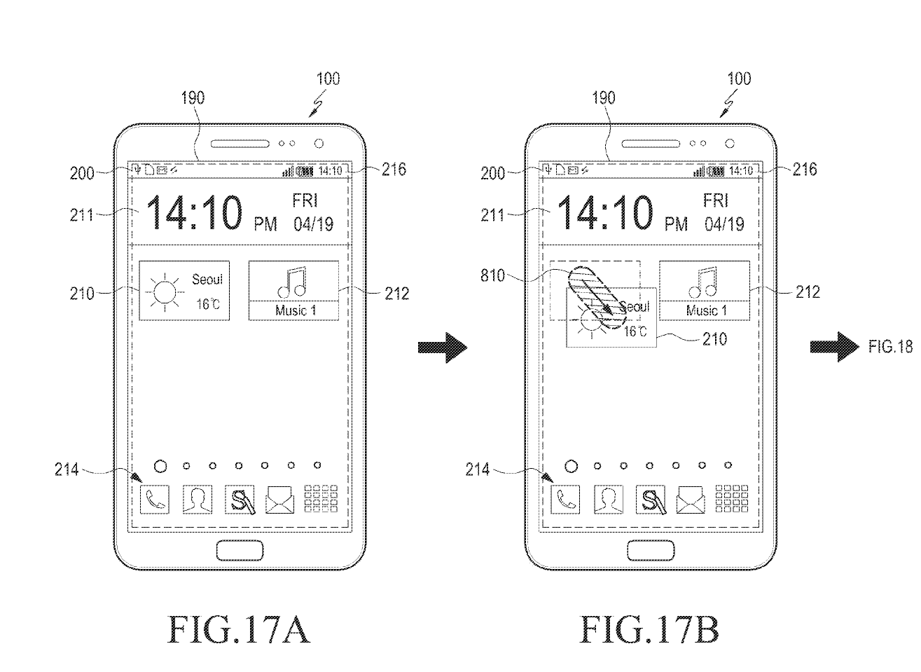

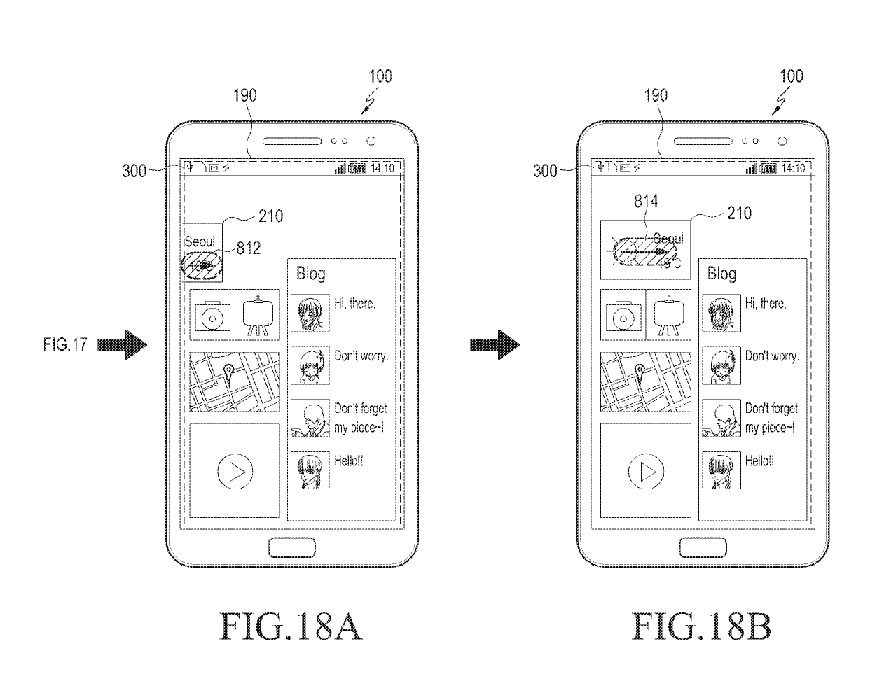

With reference to FIGS. 17A and 17B, the controller 110 may detect the changes such as, for example, the moving or the copying of the private data from the private area to the shared area. That is, as illustrated in FIG. 17A, the controller 110 may display the home screen formed with the private area 200 including the private data 210 to 216 on the display unit 190. For example, as illustrated in FIG. 17A, the controller 110 may display the home screen formed with the private area 200 comprised of private data which includes at least one of the weather widget 210, the clock widget 211, the audio file Music 1 212, the phone, the contact, the note, the message, the shortcut 214 like the application list (Apps), and the status bar 216 on the display unit 190. At this point, the controller 110 may detect the changes such as the moving or the copying the private data from the private area to the shared area. Further, the change may be detected by sensing a gesture. For example, the gesture may be a touch or hovering corresponding to a drag and drop. As illustrated in FIG. 17B, the controller 110 may detect a touch or hovering 810 corresponding to a start of a drag and drop on the private data such as the weather widget 210 on the private area 200. Subsequently, as illustrated in FIG. 18A, the controller 110 may detect a touch or hovering 812, which is a continuation of the touch or hovering 811, corresponding to a drag for moving or copying the private data such as the weather widget 210 to the shared area 300. Finally, as illustrated in FIG. 18B, the controller 110 may detect a touch or hovering 814, which is a continuation of the touch or hovering 812, corresponding to a drop for the moving or the copying of the private data such as the weather widget 210 to the shared area 300. Therefore, with reference to FIGS. 17B to 18B, the controller 110 may detect the gesture such as the drag and drop for the moving or the copying the private data such as the weather widget 210 on the private area 200 to the shared area 300. Therefore, the controller 110 may detect the changes such as the moving or copying of private data such as the weather widget 210 from the private area 200 to the shared area.

In step 1050, if changes to the shared area are detected, the changed shared area is stored in the cloud server. If the controller 110 detects changes to the shared area, the changed shared area is stored in the cloud server. That is, the controller 110 may transmit the changed shared area to the cloud server, and the cloud server may store the changed shared area.

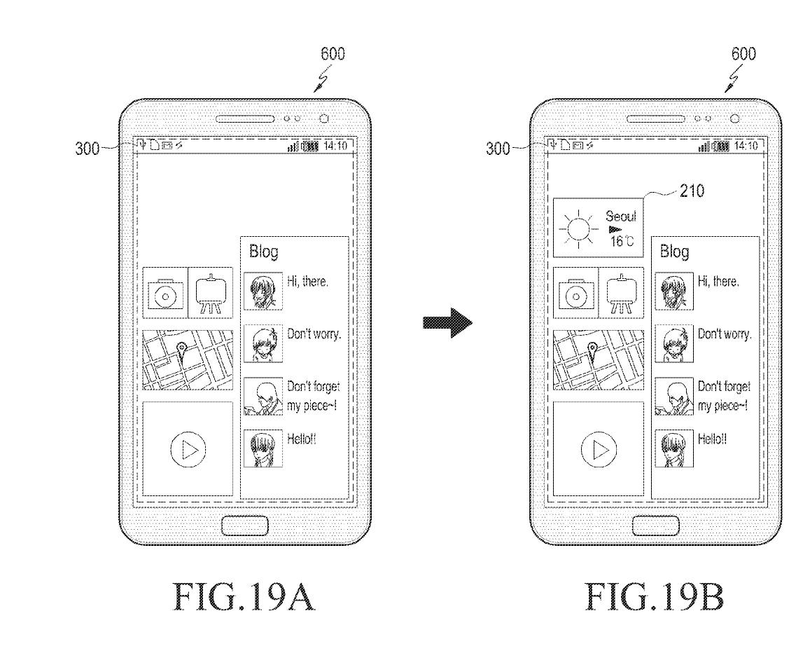

For example, if changes to the shared area are detected in the first portable apparatus 100, the controller 110 of the first portable apparatus 100 may transmit the data relating to the changed shared area to the cloud server 700 using the mobile communication module 120 or the sub-communication module 130. Therefore, the first portable apparatus 100 may share the changed shared area with the cloud server 700 in real time by transmitting the data relating to the changed shared area to the cloud server 700. In addition, the cloud server 700 may transmit the data relating to the changed shared area to the second portable apparatus 600. Therefore, the second portable apparatus 600 may receive the changed shared area changed in the first portable apparatus 100 through the cloud server 700. Therefore, the second portable apparatus 600 may share the changed shared area changed in the first portable apparatus 100 through the cloud server 700 together with the first portable apparatus 100 in real time. FIGS. 19A and 19B are diagrams illustrating a screen on which a home screen sharing method according to another embodiment of the present invention is performed in the portable apparatus. FIG. 19A illustrates the home screen formed with the shared area in the second portable apparatus 600. At this point, the second portable apparatus 600 may display the changed shared area changed in the first portable apparatus 100 received from the cloud server 700 on the home screen. For example, as illustrated in FIGS. 17A to 18B, the changes detected in the first portable apparatus 100 may be the moving or copying of private data, such as the weather widget 210, from the private area 200 to the shared area 300. At this point, as illustrated in FIG. 19B, the second portable apparatus 600 may display the weather widget 210 moved or copied to the shared area 300 on the home screen of the second portable apparatus 600. Therefore, the second portable apparatus 600 may display the shared area changed in the first portable apparatus 100 illustrated in FIG. 18B on the home screen in the same manner as illustrated in FIG. 19B. Therefore, the second portable apparatus 600 may share the changed shared area changed in the first portable apparatus 100 through the cloud server 700 together with the first portable apparatus 100 in real time.

In step 1060, changes to the private area are detected in step 1060. The controller 110 of the portable apparatus 100 may detect changes to the private area. At this point, the changes may be copying, moving, adding, or deleting. Therefore, the controller 110 may detect changes such as the copying, moving, adding, or deleting of data in the private area. In step 1070, if changes to the private area are detected, the changed private area is stored in the local database. If the controller 110 detects changes to the private area, the changed private area is stored in the local database. The local database may be included in the storage unit 175 of the portable apparatus 100. Therefore, since the changed private area is stored in the local database included in the storage unit 175, the changed private area may not be shared through the cloud server 700.

Therefore, still another embodiment of the present invention has the advantage of displaying a plurality of home screens including a first home screen displaying a private area and a second home screen displaying a shared area and moving and displaying the first home screen and the second home screen by a gesture. Further, still another embodiment of the present invention has an advantage of providing a plurality of shared areas categorized into groups. Further, still another embodiment of the present invention has an advantage of providing changed shared data by moving or copying the shared data from the private area to the shared area, moving or copying the shared data from the shared area to the private area, or deleting the shared data from the shared area.

It will be appreciated that the embodiments of the present invention may be implemented in a form of hardware, software, or a combination of hardware and software. Any such software may be stored, for example, in a volatile or non-volatile storage device such as a ROM, a memory such as a RAM, a memory chip, a memory device, or a memory Integrated Circuit (IC), or a recordable optical or magnetic medium such as a CD, a DVD, a magnetic disk, or a magnetic tape, regardless of its ability to be erased or its ability to be re-recorded. A web widget manufacturing method of the present invention can be realized by a computer or a portable terminal including a controller and a memory, and it can be seen that the memory corresponds to an example of the storage medium which is suitable for storing a program or programs including instructions by which the embodiments of the present invention are realized, and is machine readable. Accordingly, the present invention includes a program for a code implementing the apparatus and method described in the appended claims of the specification and a machine (a computer or the like)-readable storage medium for storing the program. Moreover, such a program as described above can be electronically transferred through an arbitrary medium such as a communication signal transferred through cable or wireless connection, and the present invention properly includes the things equivalent to that.

Further, the device can receive the program from a program providing apparatus connected to the device wirelessly or through a wire and store the received program. The program supply apparatus may include a program that includes instructions to execute the embodiments of the present invention, a memory that stores information or the like required for the embodiments of the present invention, a communication unit that conducts wired or wireless communication with the electronic apparatus, and a control unit that transmits a corresponding program to a transmission/reception apparatus in response to the request from the electronic apparatus or automatically.

An aspect of the present invention has an advantage in that it may generate and display a home screen which is divided into a private area including private data and a shared area including shared data.

The present invention has another advantage in that it may share a home screen formed with a shared area among a plurality of portable apparatuses through a cloud server.

The present invention has another advantage in that it can share an changed shared area among a plurality of portable apparatuses through a cloud server in real time, if the changes to the shared area are detected.

Another aspect of the present invention is that while a changed shared area may be shared among a plurality of portable apparatuses through a cloud server, a changed private area will not be shared among a plurality of portable apparatuses.

Another aspect of the present invention is that it has the advantage of sharing a shared area among participants by receiving a selection of participants and transmitting information relating to participants through a cloud server.

Another aspect of the present invention is that it has the advantage of changing the shared area only by an input from the generator who has created the shared area or by inputs from the generator and all the participants.

Still another aspect of the present invention is that it has the advantage of displaying a plurality of home screens including a first home screen displaying a private area and a second home screen displaying a shared area and moving and displaying the first home screen and the second home screen by a gesture.

Still another aspect of the present invention is that it provides a plurality of shared areas categorized into groups.

Still another aspect of the present invention is that it has the advantage of providing and changing shared data by moving or copying the shared data from the private area to the shared area, moving or copying the shared data from the shared area to the private area, or deleting the shared data from the shared area.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A home screen sharing method, comprising:
generating a home screen including a private area including private data, and a shared area including shared data;
displaying the home screen including the private area and the shared area;
sharing the shared area with a cloud server;
detecting changes to the shared area; and
storing the changes to the shared area in the cloud server.

2. The home screen sharing method of claim 1, further comprising:
detecting changes to the private area; and
storing the changes to the private area in a local database.

3. The home screen sharing method of claim 1, wherein the shared data includes at least one of content, an image, text, an audio file, a video, a shortcut, a widget, a notification, a status bar, an application, a blog, a Social Networking Service (SNS), and a chat window.

4. The home screen sharing method of claim 1, wherein the shared data is formed using Hyper Text Markup Language (HTML).

5. The home screen sharing method of claim 1, further comprising:
receiving a selection of participants with whom to share the shared area,
wherein the sharing of the shared area with the cloud server includes transmitting information relating to the participants to the cloud server and sharing the shared area only among the participants.

6. The home screen sharing method of claim 5, wherein the receiving of the selection of the participants to share the shared area includes receiving the selection of the participants using contacts stored in a phone book.

7. The home screen sharing method of claim 5, wherein the changes to the shared area include changes to the shared area only by an input from a generator of the shared area or by input from at least one of the generator and the participants.

8. The home screen sharing method of claim 1,
wherein the home screen includes a plurality of home screen pages and the plurality of home screen pages include a first home screen page displaying the private area and a second home screen page displaying the shared area,
wherein the first home screen page and the second home screen page are switched by a gesture input.

9. The home screen sharing method of claim 1, wherein the shared area includes a plurality of shared areas and the plurality of shared areas are categorized into groups.

10. The home screen sharing method of claim 1, wherein the changes to the shared area include moving or copying private data from the private area to the shared area, moving or copying shared data from the shared area to the private area, or deleting shared data from the shared area.

11. A home screen sharing apparatus, comprising:
a controller configured to generate a home screen including a private area including private data, and a shared area including shared data, to display the home screen including the private area and the shared area, to share the shared area with a cloud server, to detect changes to the shared area, and to store the changes to shared area in the cloud server;
a display unit configured to display the home screen; and
a storage unit configured to store the private and shared data.

12. The home screen sharing apparatus of claim 11, wherein the controller detects changes to the private area, and stores the changes to the private area in a local database.

13. The home screen sharing apparatus of claim 11, wherein the shared data includes at least one of content, an image, text, an audio file, a video, a shortcut, a widget, a notification, a status bar, an application, a blog, a Social Networking Service (SNS), and a chat window.

14. The home screen sharing apparatus of claim 11, wherein the shared data is formed using Hyper Text Markup Language (HTML).

15. The home screen sharing apparatus of claim 11, wherein the controller receives a selection of participants to share the shared area, transmits information relating to the participants to the cloud server, and shares the shared area only among the participants.

16. The home screen sharing apparatus of claim 15, wherein the controller receives the selection of the participants using contacts stored in a phone book.

17. The home screen sharing apparatus of claim 15, wherein the controller changes the shared area only by an input from a generator of the shared area or by input from at least one of the generator and the participants when changing the shared area.

18. The home screen sharing apparatus of claim 11,
wherein the home screen includes a plurality of home screen pages and the plurality of home screen pages include a first home screen page displaying the private area and a second home screen page displaying the shared area,
wherein the first home screen page and the second home screen page are switched by a gesture input.

19. The home screen sharing apparatus of claim 11, wherein the shared area includes a plurality of shared areas and the plurality of shared areas are categorized into groups.

20. The home screen sharing apparatus of claim 11, wherein the changes include moving or copying private data from the private area to the shared area, moving or copying shared data from the shared area to the private area, or deleting shared data from the shared area.
